(19) United States
(12) Patent Application Publication
(10) Pub. No.: US 2011/0283121 A1
(43) Pub. Date: Nov. 17, 2011

(54) MANAGEMENT APPARATUS, SYSTEM INCLUDING THE MANAGEMENT APPARATUS AND MULTIPLE DEVICES, AND METHOD OF CONTROLLING THE APPARATUS AND THE SYSTEM

(75) Inventor: Yuji KURODA, Tokyo (JP)

(73) Assignee: CANON KABUSHIKI KAISHA, Tokyo (JP)

(21) Appl. No.: 13/100,544

(22) Filed: May 4, 2011

(30) Foreign Application Priority Data
May 12, 2010 (JP) 2010-110594

(51) Int. Cl. G06F 1/32

(52) U.S. Cl. 713/310

(57) ABSTRACT

In a system including multiple devices and a management apparatus, the management apparatus receives target power consumption, and a setting of a time period for performing power saving control, calculates target power consumption of each device and sets the calculated target power consumption for each device. When a power amount reallocation request is received from a first device in which power consumption of the device has reached a power saving transition power amount within the time period, the management apparatus calculates predicted power consumption of each of the multiple devices when the time period ends and chooses a second device that will not reach the corresponding power saving transition power amount of the device by the end of the time period and determines an amount of power consumption allocatable from the second device to the first device is determined.

### BACKGROUND OF THE INVENTION

1. Field of the Invention

The present invention relates to technology for controlling power consumption of each of multiple devices in a system including the devices.

2. Description of the Related Art

Conventionally, power control technology is known in which a reference amount of power serving as a target is determined with respect to power consumed by a device, and the power consumption of the device is controlled based on the reference amount of power. Specifically, the amount of power consumption serving as a fixed target is set as a reference value with respect to the power consumed by an image forming apparatus. Power saving is realized by causing the image forming apparatus to transition to an electric power saving mode such as a sleep mode or adjusting an elapsed time period for transitioning to the electric power saving mode, based on the reference value.

Japanese Patent Laid-Open No. 2003-032397 proposes technology, in a system in which multiple image forming apparatuses are connected via a network, for efficiently controlling power consumption of the entire system. According to this technology, an electric power saving mode of each image forming apparatus is controlled so as to shorten a wait time period until the operation of an image forming apparatus desired to be used by each user starts. Specifically, it is determined whether the total power consumed by the multiple apparatuses has exceeded an upper limit value, and if the upper limit value has been exceeded, all the image forming apparatuses are caused to transition to a power saving state, and when the total power consumption falls below the upper limit value as a result, an image forming apparatus having a high priority is placed in a ready state of being operable.

However, with this conventional technology, a time period for performing control based on the upper limit value is not set. Accordingly, the image forming apparatuses can be used for as long as the power consumption remains below the upper limit value. Further, in the conventional example, even when the power consumption falls below the upper limit value, image forming apparatuses to become operable are determined based on priorities set in advance. Accordingly, after the power consumption reaches the upper limit value, all the image forming apparatuses having a low priority enter a power saving state, which causes a feeling of unfairness among the users of these image forming apparatuses.

In an actual office network environment, multiple image forming apparatuses vary in terms of function, performance, operating time period, and operating content. In order to control the amount of power consumed by the image forming apparatuses in the entire system in such a use environment, it is necessary to perform power control in consideration of the usage of the image forming apparatuses and the like, although such technology has not be proposed.

### SUMMARY OF THE INVENTION

An aspect of the present invention is to eliminate the above-mentioned problems with the conventional technology.

A feature of the invention of the application is to provide technology, in a network system including multiple devices, for enabling overall power consumption to be controlled without impairing the convenience with which the devices are operated as much as possible.

According to an aspect of the present invention, there is provided a system including a plurality of devices and a management apparatus capable of communicating with the plurality of devices, wherein the management apparatus comprises: a reception unit that receives target power consumption of the entire system, and a setting of a time period for performing power saving control; a setting unit that calculates target power consumption of each device based on the target power consumption of the entire system, and sets the calculated target power consumption for the each device; an obtaining unit that obtains a power amount reallocation request from a first device in which power consumption of the device has reached a power saving transition power amount corresponding to the target power consumption of the first device; a calculation unit that calculates, in response to the reallocation request, predicted power consumption of each of the plurality of devices for a point in time when the time period ends, based on power consumption of each of the devices other than the first device and a remaining time period up to the end of the time period; and an update unit that, based on the predicted power consumption of each of the devices other than the first device calculated by the calculation unit, and the power saving transition power amount and the power consumption of each of the devices, chooses a second device that will not reach the corresponding power saving transition power amount of the device by the end of the time period, determines an amount of power consumption allocatable from the second device to the first device, and updates the power saving transition power amounts of the first and second devices, and each of the devices comprises: a measurement unit that measures power consumption of the device; a transmission unit that, if the power consumption of the device measured by the measurement unit reaches the power saving transition power amount of the device, transmits the power amount reallocation request to the management apparatus; a transition power update unit that receives the power saving transition power amount updated by the update unit from the management apparatus in response to the reallocation request, and updates the power saving transition power amount corresponding to the device; and a control unit that controls whether to cause the device to transition to an electric power saving mode, based on the power consumption of the device and the power saving transition power amount corresponding to the device.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing an example of the configuration of a power saving control system according to an embodiment of the present invention.

FIG. 2 is a block diagram showing the configuration of an image forming apparatus according to the embodiment.

FIG. 3 is a block diagram showing the configuration of a management apparatus according to the embodiment.

FIG. 4 is a block diagram showing the configuration of an electric power measurement apparatus according to the embodiment.

FIG. 5 is a diagram showing an example of a target power consumption setting screen displayed on a console unit of the management apparatus.

FIG. 6 is a diagram showing examples of screens displayed on the console unit of the management apparatus.

FIG. 7 is a diagram illustrating a specific example of target power amount control described with reference to FIGS. 5 and 6.

FIGS. 8A and 8B are diagrams illustrating specific examples of accumulated power consumption during a predetermined time period with the amounts of allocation to devices shown in FIG. 7.

FIG. 9 is a diagram illustrating power consumption of the devices after the power amount has been transferred to device A from devices B to D.

FIGS. 10A and 10B are flowcharts describing operation of the image forming apparatus and the management apparatus.

FIG. 11A is a diagram showing an example of a power saving control setting screen displayed on a console unit of the image forming apparatus.

FIG. 11B is a diagram showing an example of a sleep mode transition time period setting screen.

FIG. 12A is a diagram showing an example of a print layout setting screen displayed on the console unit of the image forming apparatus.

FIG. 12B is a diagram showing an example of a print color setting screen.

FIG. 13 is a diagram showing an example of a backlight setting screen of the power saving control setting screens.

FIG. 14 is a flowchart describing operation of the image forming apparatus in an electric power saving mode.

FIG. 15 is a flowchart describing operation related to job registration of the image forming apparatus.

### DESCRIPTION OF THE EMBODIMENTS

An embodiment of the present invention will now be described hereinafter in detail, with reference to the accompanying drawings. It is to be understood that the following embodiment is not intended to limit the claims of the present invention, and that not all of the combinations of the aspects that are described according to the following embodiment are necessarily required with respect to the means to solve the problems according to the present invention.

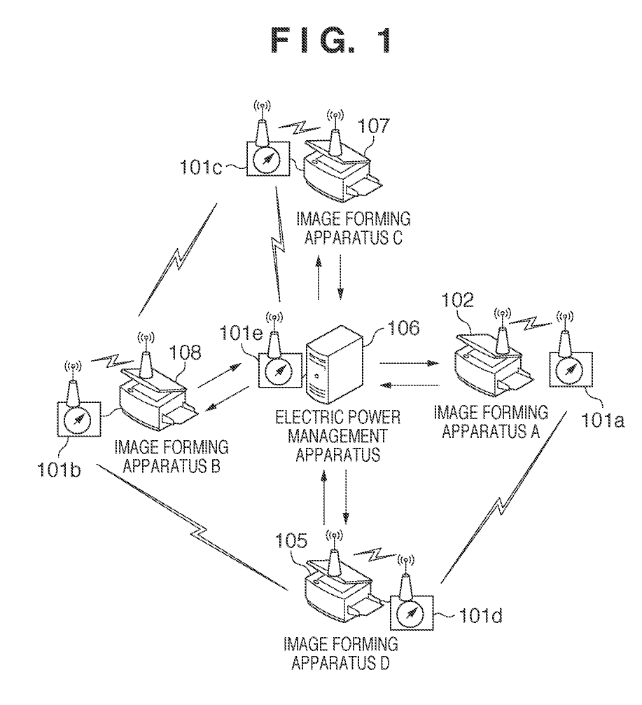

FIG. 1 is a diagram showing an example of the configuration of a power saving control system according to the present embodiment.

This power saving control system includes multiple image forming apparatuses (devices) A to D (102, 105, 107, 108) such as printers, multifunction peripherals, and fax machines. Further, the system includes an electric power management apparatus (hereinafter, management apparatus) 106 that manages power consumption of the image forming apparatuses, and electric power measurement apparatuses 101 (101a to 101e) that respectively measure the power consumed by the corresponding image forming apparatuses. An example is shown in which information transmission between the apparatuses that constitute this system is performed by wireless communication. In this case, each image forming apparatus communicates with the management apparatus 106 and the electric power measurement apparatus 101 directly or by relay using multihop wireless communication. Note that information transmission is not limited to wireless communication, but may be performed by wired communication as long as a configuration that allows communication is adopted. Further, although the electric power measurement apparatuses 101 are arranged outside the image forming apparatuses in FIG. 1, each image forming apparatus may contain the electric power measurement apparatus if power consumption of the image forming apparatus can be measured, and the measured information can be transmitted and received. The electric power measurement apparatuses 101 may perform determination, for example, with reference to a table or the like, based on the number of images formed (printed) by the respective image forming apparatuses during a fixed time period, the image type (color/monochrome), the amount of toner consumption, and the like.

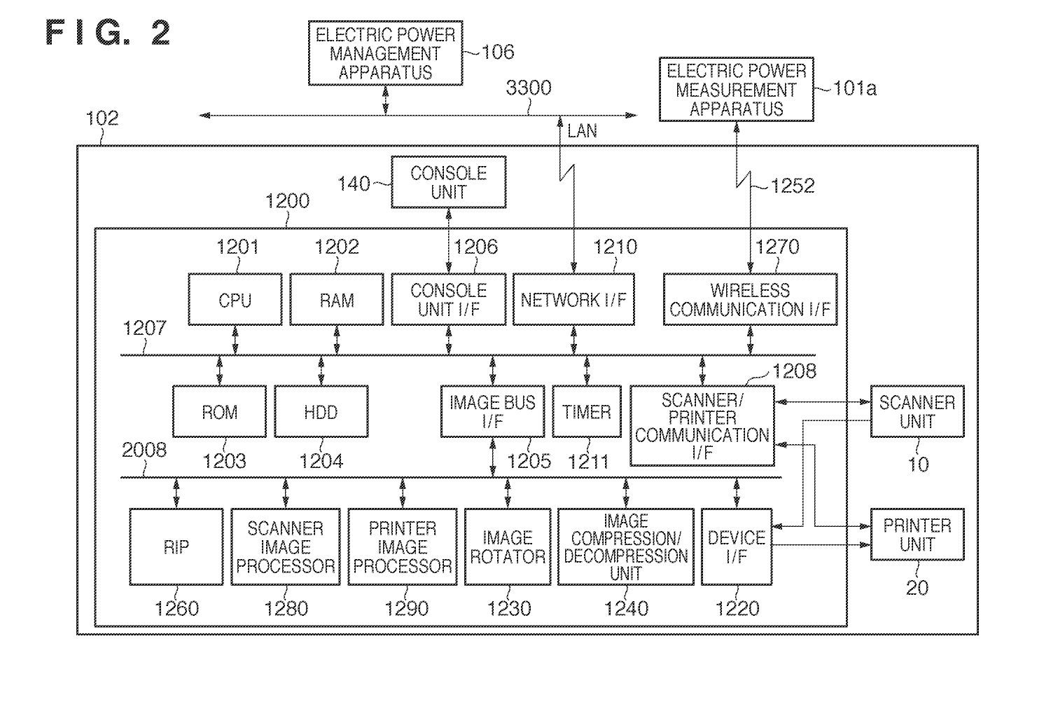

The image forming apparatus 102 receives information on the power consumption of the image forming apparatus 102 from the electric power measurement apparatus 101a. Further, the image forming apparatus 102 receives power saving control time period information and a target power value from the management apparatus 106. The image forming apparatus 102 implements power consumption control, based on the received information and power saving control setting values set by a user using a console unit 140 (FIG. 2). Similarly, the other image forming apparatuses 105, 107, and 108 also respectively receive information on power consumption from the corresponding electric power measurement apparatuses 101d, 101c, and 101b. Then, each of the image forming apparatuses receives power saving control time period information and a target power value from the management apparatus 106, and implements power consumption control based on the received information and power saving control setting values set by the user using the console unit 140 (FIG. 2).

FIG. 2 is a block diagram showing the configuration of an image forming apparatus according to the present embodiment. In the following, although the configuration of the image forming apparatus 102 is described as an example, the configuration and operation of the other image forming apparatuses are also assumed to be basically the same.

A controller unit 1200 is connected to a scanner unit 10 that reads an original image, and a printer unit 20 that performs printing. Further, the controller unit 1200 is connected to a host computer (not shown), the electric power measurement apparatus 101a, the management apparatus 106, and other external devices (not shown), by being connected to a LAN 3300 or a wireless LAN 1252. A CPU 1201 performs overall control of the image forming apparatus 102. A RAM 1202 provides a memory for expanding a program when the CPU 1201 operates and a work memory, and is furthermore used to temporarily store image data and the like. A ROM 1203 is a boot ROM, which stores a boot program. An HDD 1204 is a hard disk drive, which stores various software, image data, a software counter value, target power consumption, information on the power consumption received from the electric power measurement apparatus 101a, and the like. As the software counter value, a count value obtained by counting the number of printed images is stored. The storage location of the count value is not limited to the HDD 1204, as long as the count value is stored in a nonvolatile area. A console unit interface 1206 performs a role of outputting image data to be displayed on the console unit 140 to the console unit 140 and conveying information input by the user using the console unit 140 to the CPU 1201. A network interface 1210 is connected to the LAN 3300, and inputs/outputs information to/from the LAN 3300. A wireless communication interface 1270 inputs/outputs information to/from the wireless LAN 1252. A scanner/printer communication interface 1208 is an interface for communicating with both the scanner unit 10 and the printer unit 20. A timer 1211 has a function of clocking the time of the image forming apparatus 102 and generating an interrupt at fixed time intervals. An image bus interface 1205 connects an image bus 2008 that transfers image data at high speed with a system bus 1207, and functions as a bus bridge that converts a data structure.

The following devices are arranged on the image bus 2008. A raster image processor (RIP) 1260 develops PDL code into a bitmap image. A device interface 1220 is connected to the scanner unit 10 and the printer unit 20, and performs synchronous/asynchronous conversion of image data. A scanner image processor 1280 corrects, processes, and edits image data obtained by reading an original with the scanner unit 10. A printer image processor 1290 performs correction, resolution conversion, and the like on image data to be output to the printer unit 20. An image rotator 1230 rotates image data. An image compression/decompression (CODEC) unit 1240 performs compression and decompression processing using JPEG in the case of multi-value image data, and performs compression and decompression processing using JPEG, MMR, MH or the like in the case of binary image data.

The image forming apparatus 102 is provided with a sleep mode for power saving. The CPU 1201 performs control for an operational mode transition to this sleep mode. Specifically, the CPU 1201 can independently control blockage and supply of power supply to units such as the printer unit 20, the scanner unit 10, and the console unit 140 by determining the operational status of the image forming apparatus 102. For example, in the case where only the scanner function is used, the CPU 1201 blocks power supply to the printer unit 20 and the printer image processor 1290. On the other hand, in the case were only the printer function is used, the CPU 1201 reduces the power consumption of the entire apparatus by blocking power supply to the console unit 140, the scanner unit 10, the scanner image processor 1280, and the like.

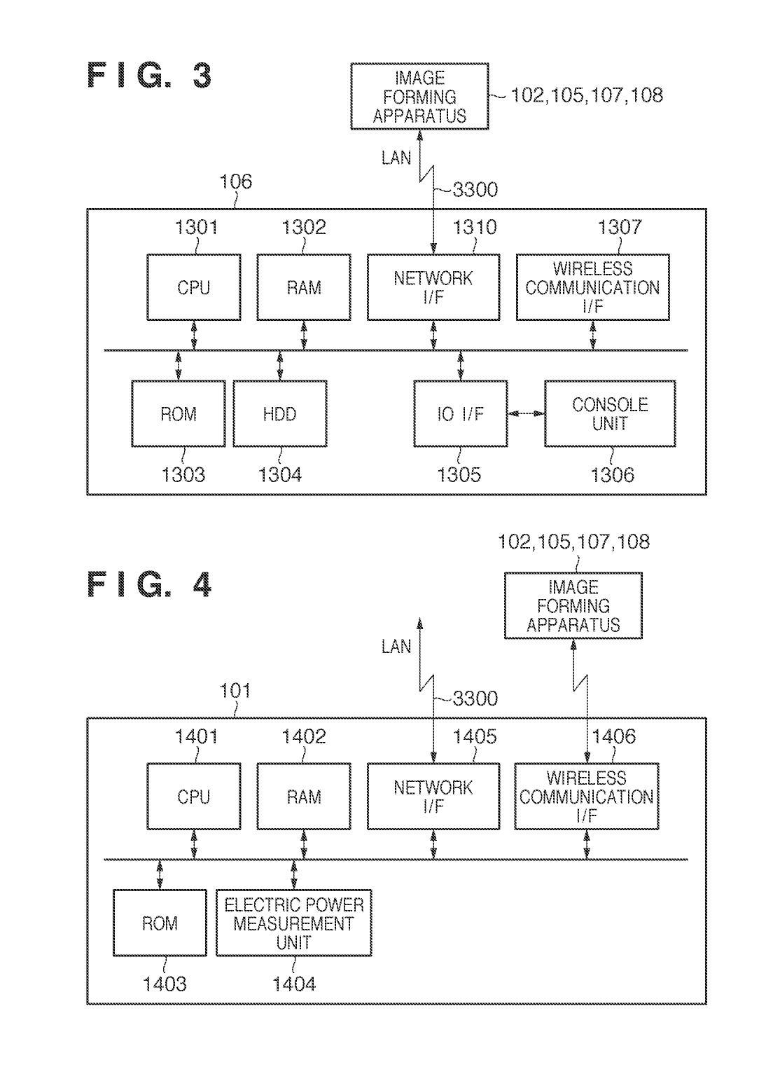

FIG. 3 is a block diagram showing the configuration of the management apparatus 106 according to the present embodiment.

The management apparatus 106 controls the power consumption in the power saving control system according to the present embodiment. A CPU 1301 performs overall control of the management apparatus 106 by executing a control program loaded into a RAM 1302. The RAM 1302 stores programs for the CPU 1301, and is also used as a work memory when the CPU 1301 operates. A ROM 1303 is a boot ROM, which stores a boot program. An HDD 1304 is a hard disk drive, which stores system software, target power consumption, power consumption received from image forming apparatuses, and the like. A network interface 1310 is connected to the LAN 3300, and transmits/receives data to/from the LAN 3300. A wireless communication interface 1307 communicates with the image forming apparatuses by wireless communication, and receives power consumption and transmits target power consumption. An input/output interface 1305 inputs/outputs information to/from a console unit 1306 that has a liquid crystal display unit, a keyboard, a touch panel, and the like. Various setting instructions for setting target power consumption and the like in the power saving control system according to the present embodiment can be received via the console unit 1306.

Note that the configuration of the management apparatus 106 is based on the configuration of a general purpose computer. However, the present invention is not limited to this configuration, as long as the configuration allows management of the power consumption and reception of instructions for setting target power consumption and the like in the power saving control system according to the present embodiment. For example, one of the image forming apparatuses shown in FIG. 1 may play that role.

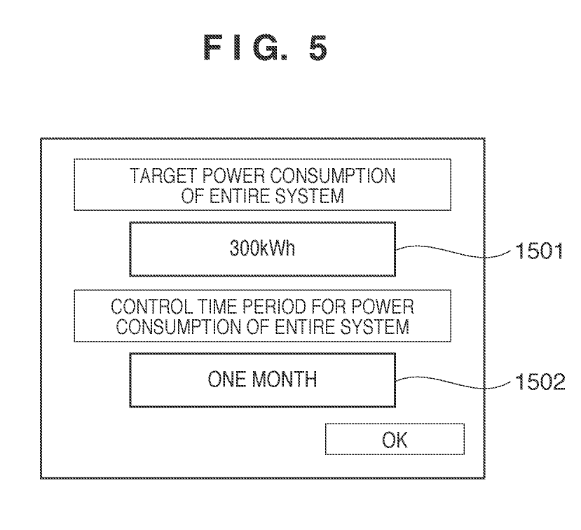

FIG. 4 is a block diagram showing the configuration of the electric power measurement apparatuses 101 according to the present embodiment.

The electric power measurement apparatuses 101 each measure the power consumption of the corresponding image forming apparatus, and transmit the result of the measurement to the corresponding image forming apparatus. A CPU 1401 controls power consumption measurement, measurement result transmission, and the like by executing a control program stored in a RAM 1402. The RAM 1402 provides a work memory for the CPU 1401 to operate. The image forming apparatuses are each supplied power via an electric power measurement unit 1404 of the corresponding electric power measurement apparatus 101 (see FIG. 1). The electric power measurement unit 1404 directly measures the amount of power on a primary side supplied to the corresponding image forming apparatus. The CPU 1401 inputs information such as the power consumption that results from this measurement, and stores the information in the RAM 1402. A ROM 1403 stores various software executed by the CPU 1401. A network interface 1405 is connected to the LAN 3300, and transmits/receives data via the LAN 3300. A wireless communication interface 1406 wirelessly communicates with the image forming apparatus, and transmits information on the power consumption and the like in response to a request from the image forming apparatus. Note that transmission/reception of information to/from the image forming apparatus is not limited to being performed by wireless communication, and may be performed by a LAN connection interface via the network interface 1405.

Note that a configuration may be adopted in which functions of the electric power measurement apparatus 101 are provided in the image forming apparatus as an electric power measurement unit, as long as the power consumption of the image forming apparatus can be measured.

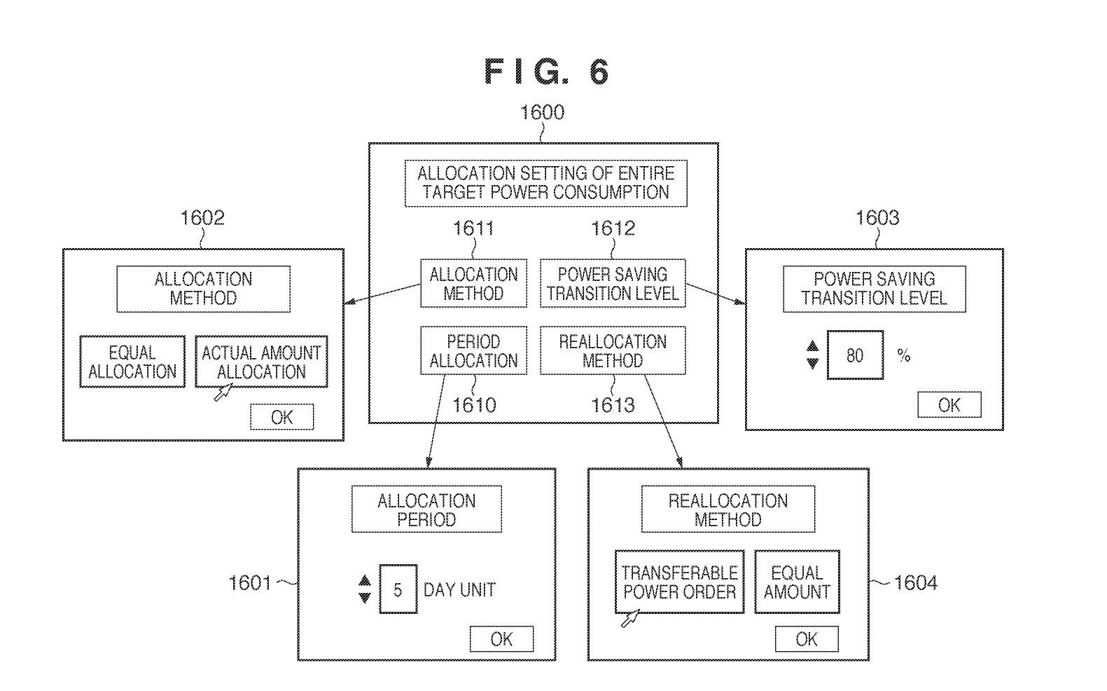

FIG. 5 is a diagram showing an example of a setting screen of power consumption serving as a target displayed on the console unit 1306 of the management apparatus 106.

This screen has an input field 1501 for target power consumption of the entire system and an input field 1502 for a power control time period for performing power saving control of the entire system. The values input in these input fields are used as values for calculating the target amount of power of each image forming apparatus as power saving control parameters of the entire system. In the example in FIG. 5, the target power consumption is set to “300 kWh”, and the power control time period is set to “one month”. Accordingly, power control is designated in which an accumulated power consumption (target power consumption) serving as a target of the entire system for one month is set to “300 kWh”.

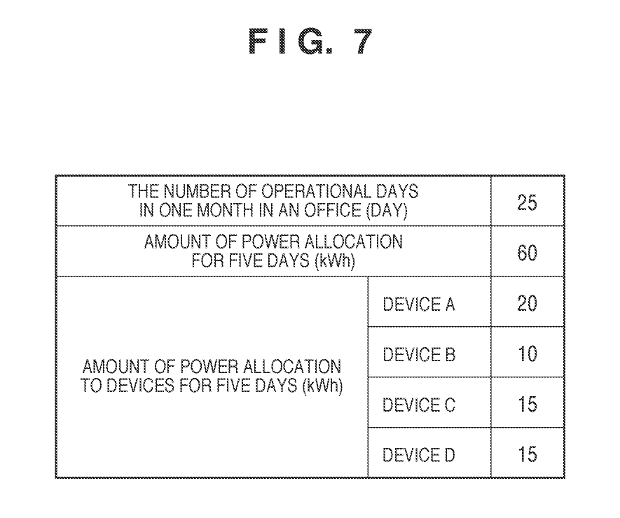

FIG. 6 is a diagram showing examples of screens displayed on the console unit 1306 of the management apparatus 106 according to the present embodiment. Here, examples of screens are shown in which advanced conditions for calculating a target value of the power consumption to be set for each image forming apparatus (here, referred to as device) are set with respect to the target power consumption of the entire system.

An advanced settings screen 1600 is a screen for making advanced settings for allocating the amount of target power consumption of the entire system to the devices. A period allocation button 1610 is for designating the number of days by which the target amount of power consumption is divided for each device with respect to the power saving control time period (one month in FIG. 5) for the entire system. When the period allocation button 1610 is instructed, a period allocation setting screen 1601 is displayed. Here, the number of days by which the target amount of power consumption is divided is set to “five days” with respect to the target power control time period (one month) shown in FIG. 5. Note that the number of days (allocation period) for division does not necessarily need to be designated, and can be omitted. If the input of an allocation period is omitted, the time period set in the input field 1502 in FIG. 5 serves as this allocation period.

An allocation method button 1611 is a button for designating a method for determining the amount of power consumption to be allocated to the devices, and when this button 1611 is instructed, transition is performed to an allocation method setting screen 1602. Here, it is possible to choose whether to determine the allocation amount of the target amount of power for the allocation period (here, five days) based on a past (one month or previous time period) actual amount (“actual amount allocation”) or to allocate the target amount of power equally to the devices (“equal allocation”). In the case of “actual amount allocation”, the amount of power to be allocated is determined based on the power consumption received from the devices and stored in the management apparatus 106.

A power saving transition level button 1612 is a button for designating setting of the accumulated power consumption at which the devices transition to the electric power saving mode as a percentage of the target power consumption of each device. When this button 1612 is instructed, a power saving transition level setting screen 1603 is displayed. Here, the level for transitioning to power saving is input in the percentage with the target amount of power taken as “100”, and “80%” is set in the example in FIG. 6.

A reallocation method button 1613 is a button for determining a transfer method in the case where an amount of power consumption is transferred from a device whose accumulated power consumption is below the target power consumption to a device whose accumulated power consumption has reached the target power consumption. When this button 1613 is instructed, transition is performed to a reallocation method setting screen 1604. Here, it is possible to choose between performing transfer in order of transferable amounts of power (transferable power order) or in equal amounts of power from each device (equal amount).

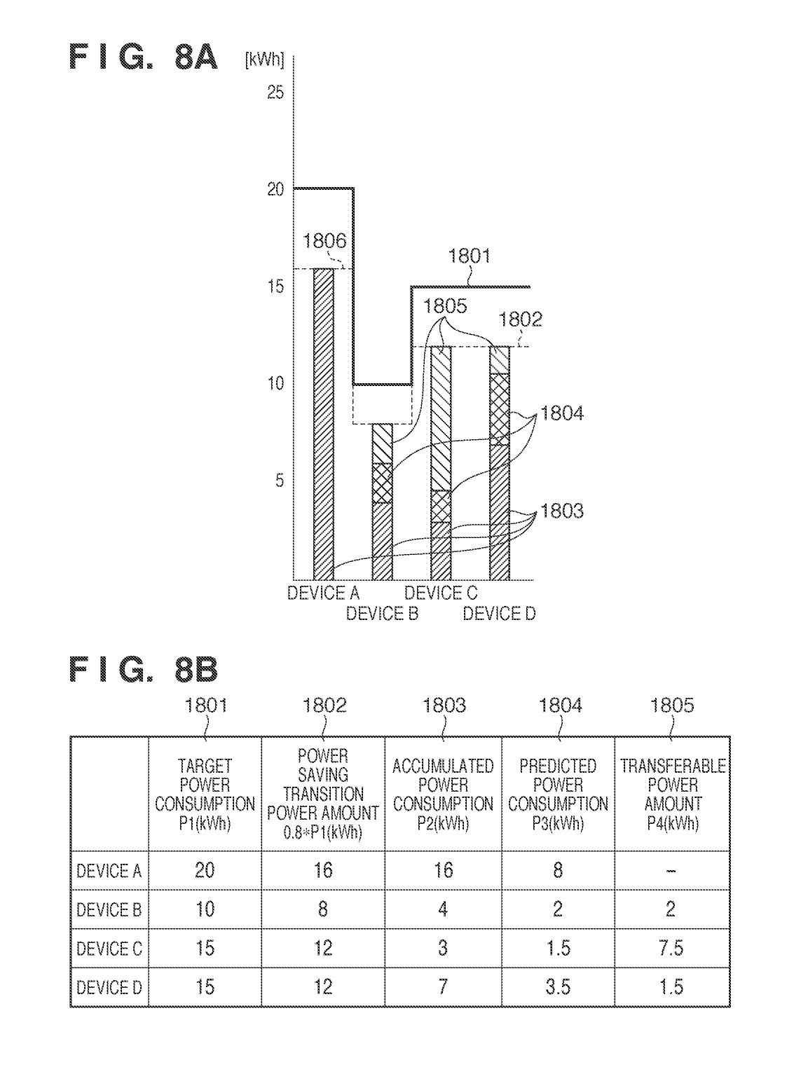

FIG. 7 is a diagram illustrating a specific example of target power amount control described with reference to FIGS. 5 and 6.

In FIG. 5, the target power consumption and the control time period of the entire system are respectively set to “300 kWh” and “one month”, and in FIG. 6, the period allocation is set to “five days”, and the allocation method to the devices is set to “actual amount allocation”.

In this case, if the number of operational days in one month of a certain office is assumed to be, for example, 25 days, the allocation of the amount of power consumption of the entire system for five days is as follows: 300/(25/5)=60 [kWh]. Further, it is assumed that the allocation to the devices (image forming apparatuses) A to D is respectively set to 20 kWh, 10 kWh, 15 kWh, and 15 kWh, based on the accumulated power consumption of each device for the whole time period. This is determined based on the accumulated power consumption received from each device (image forming apparatus) and stored in the management apparatus 106.

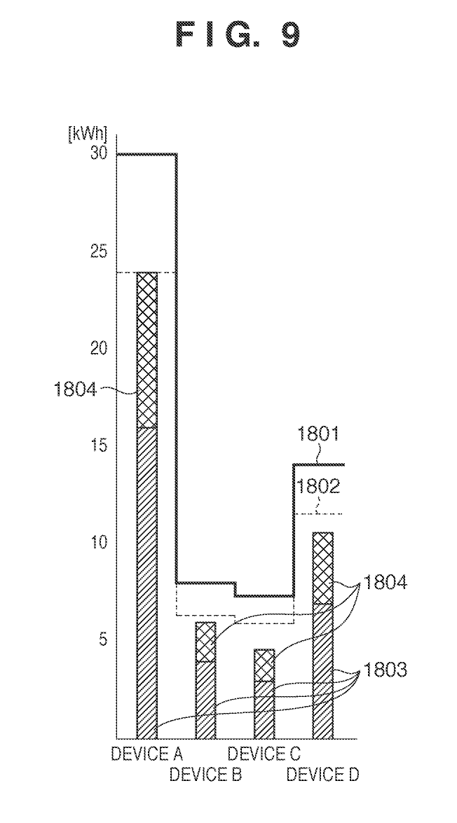

FIGS. 8A and 8B are diagrams illustrating examples of accumulated power consumption within a predetermined time period with the amounts of allocation to the devices shown in FIG. 7.

In FIG. 8A, a solid line 1801 indicates a target amount of power (P1) for a predetermined time period (for five days) allocated to the devices A to D in FIG. 7. A dotted line 1802 indicates an electric power saving mode transition threshold value (P1×80%) set in the power saving transition level setting screen 1603 in FIG. 6. If the accumulated power consumption of a device reaches the level shown by the dotted line 1802, the device transitions to the electric power saving mode. Reference numeral 1803 denotes the accumulated power consumption (P2) of each device in real time measured and accumulated by the electric power measurement apparatus 101 corresponding to the device, for example, in the fourth days (80 hours (3 days and 8 hours). Reference numeral 1804 denotes predicted power consumption (P3) that each device is predicted to consume for the remaining time period obtained by subtracting the elapsed time period from the time when measurement of the power consumption is started to the present point in time from the allocation period for allocation determination (five days). Further, reference numeral 1805 denotes the amount of power expected to be surplus in the devices at the end of five days based on the prediction, which is the transferable amount of power (P4) to another device (the device A in FIG. 8).

Below is a detailed description. As shown by 1806, in the time period of five days (T1=120 hours), the accumulated power consumption of the device A (first device) has reached the power saving transition power line 1802 when 80 hours (T2) on the fourth days have elapsed. At this point in time, the transferable power 1805 of the devices other than the first device, which is the device A, is calculated. P3 and P4 are respectively calculated using the following calculation formulas on the above conditions.

P3=P2×(T1−T2)/T1

P4=0.8×P1−(P2+P3)

FIG. 8B is a diagram showing specific examples of the target amount of power (P1), the accumulated power consumption up to the present point in time (P2), the predicted power consumption at the point in time when five days end (P3), and the transferable amount of power (P4) of each device.

In the present embodiment, “transferable power order” is chosen as the allocation method in the reallocation method setting screen 1604 in FIG. 6. In the example in FIG. 8B, although the total power consumption of the device A has reached the amount of power for transitioning to the electric power saving mode, the predicted power consumption that the device will consume from now on is 8 kWh. The amount of power necessary for the device A for the remaining time period (one day) is calculated using the following calculation formula.

$$\begin{matrix}( ( 0.8 \times P 1 + P 3 ) / ( 0.8 ) - P 1 = ( 16 + 8 ) / 0.8 - 20 \\ = 30 - 20 \\ = 10\end{matrix}$$

This shows that the power amount of 10 kWh is necessary for the device A.

Since “transferable power order” is set as the reallocation method in FIG. 6, 7.5 kWh, which is the largest transferable (allocatable) amount, is transferred from the device C (second device) that can transfer the largest amount of power, and 2 kWh, which is the transferable (allocatable) amount, is transferred from the device B that can transfer the second largest amount of power. Then, the remaining power amount of 0.5 kWh is transferred from the device D to the device A.

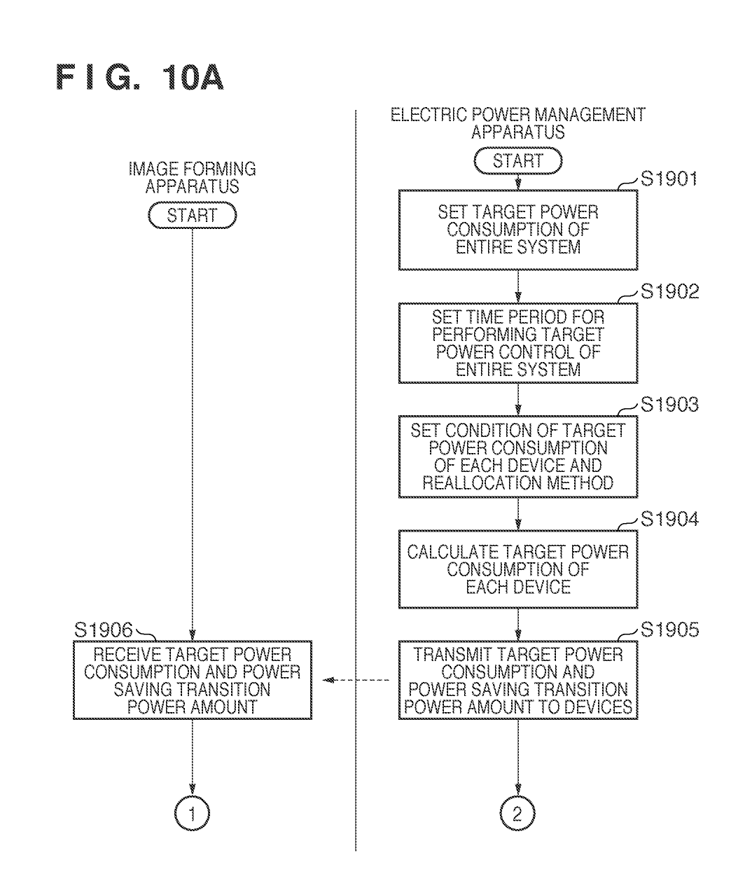

FIG. 9 is a diagram illustrating power consumption of the devices after the above amounts of power have been transferred to the device A from the devices B to D. By transferring the amounts of power to the device A from the devices B to D, the target power consumption 1801 and the power saving transition power amount 1802 of each device are changed. Specifically, in FIG. 9, the target power consumption 1801 of the devices B to D is reduced according to the amounts of power transferred from the respective devices to the device A, and the power saving transition power amount 1802 is also reduced following this. In contrast, the target power consumption 1801 of the device A is increased by the amount of power transferred from the devices B to D, and the power saving transition power amount 1802 is also increased following this. Note that reference numerals 1801 to 1804 in FIG. 9 are the same as the reference numerals in FIG. 8.

Accordingly, the device A can continue operation (printing) without transitioning to the electric power saving mode. Further, the predicted accumulated power consumption of all the devices A to D after five days elapsed will be the power saving transition power amount 1802 or less, and thus all the devices are allowed to operate without transitioning to the electric power saving mode, while suppressing the power consumption of the entire system within the time period set in FIG. 6.

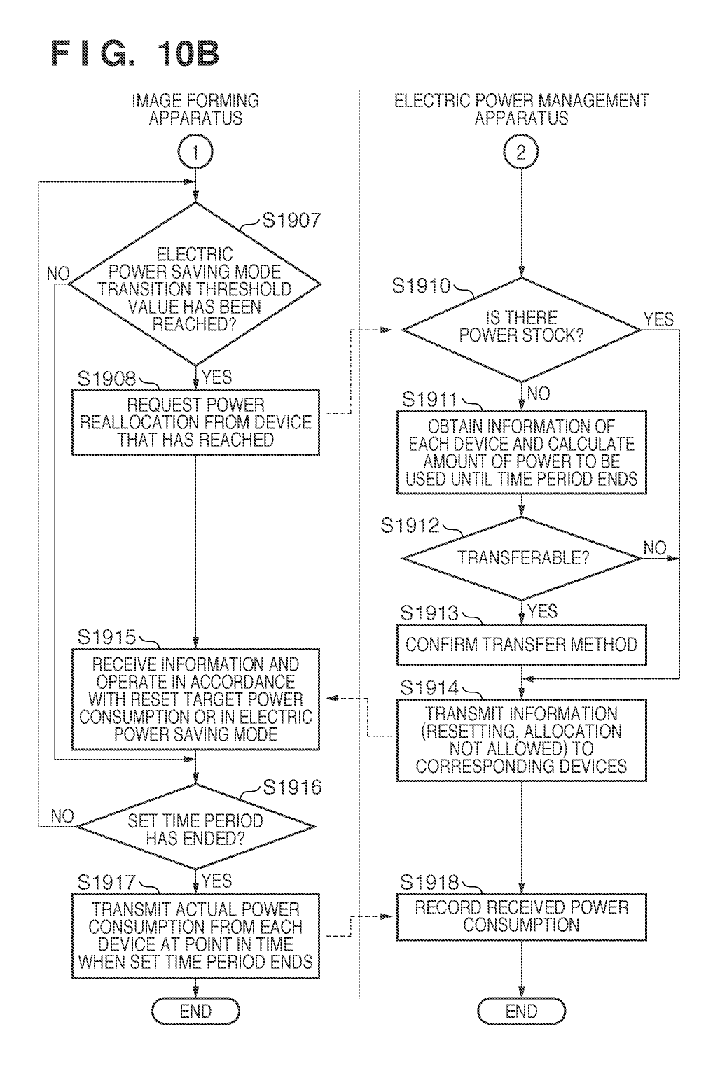

FIGS. 10A and 10B are flowcharts describing the operation of the image forming apparatuses and the management apparatus according to the present embodiment. Note that the operation of the image forming apparatuses is achieved by the CPU 1201 executing control processing in accordance with the program loaded into the RAM 1202. Further, the operation of the management apparatus 106 is achieved by the CPU 1301 executing control processing in accordance with the program loaded into the RAM 1302.

First, in step S1901 in FIG. 10A, the CPU 1301 of the management apparatus 106 receives a setting of target power consumption via the input field 1501 in the target power consumption setting screen (FIG. 5) displayed on the console unit 1306, and records the set amount of power in the RAM 1302 and the HDD 1304. Next, in step S1902, the CPU 1301 receives a setting of a power control time period via the input field 1502 in the setting screen, and records the set time period in the RAM 1302 and the HDD 1304. In FIG. 5, 300 kWh is input as the target power consumption, and one month (30 days) is input as the power control time period. Next, in step S1903, the CPU 1301 receives the input of advanced settings of calculation of target power consumption to be set with respect to each image forming apparatus, the reallocation method, and the like via the allocation setting screen 1600 (FIG. 6), and records the input content in the RAM 1302 and the HDD 1304. In FIG. 6, “five-day” unit is set in the period allocation setting screen 1601, “actual amount allocation” is set in the allocation method setting screen 1602, “80%” is set in the power saving transition level setting screen 1603, and “transferable power order” is set in the reallocation method setting screen 1604.

Next, the processing proceeds to step S1904, where the CPU 1301 calculates a target value of the power consumption to be set for each image forming apparatus based on the conditions input in steps S1901 and S1903. In this case, as shown in FIG. 7, in the case where, for example, the number of operational days in one month of a certain office is 25 days, the total amount of power for five days out of 25 days is calculated. Further, the amount of power consumption to be allocated to each image forming apparatus is calculated based on the actual amount in the last month or for the last five days. Next, the processing proceeds to step S1905, where the CPU 1301 transmits information on the target power consumption and the amount of power for transitioning to the electric power saving mode to all the image forming apparatuses via the LAN 3300.

Accordingly, in step S1906, the CPU 1201 of each image forming apparatus receives information on the target power consumption and the power saving transition power amount transmitted from the management apparatus 106, and records the received information in the RAM 1202 and the HDD 1204. Next, the processing proceeds to step S1907 (FIG. 10B), where the CPU 1201 starts target power consumption control based on the received information on the target power consumption. Then, in step S1907, the CPU 1201 determines whether or not the accumulated power consumption within the designated time period (here, five days) received from the corresponding electric power measurement apparatus 101 has reached the power saving transition power amount. If the CPU 1201 determines in step S1907 that the power saving transition power amount has been reached, the processing proceeds to step S1908, where the CPU 1201 transmits a power reallocation request to the management apparatus 106 via the LAN 3300, together with the value of the accumulated power consumption.

Consequently, in step S1910 (FIG. 10B), the CPU 1301 of the management apparatus 106 confirms the presence/absence of a power stock (amount of power surplus in the previous month or the last set time period) that is recorded in the HDD 1304 based on the received information. Here, the processing transitions to step S1911 if the amount of power required by the image forming apparatus is not in the power stock, whereas if there is a power stock, the processing proceeds to step S1914. In step S1911, the CPU 1301 extracts information on the accumulated amount of power that has been consumed by other image forming apparatuses connected to the LAN 3300 within the time period up to then and calculates the predicted power consumption for the point in time when the set time period (five days) ends. Next, the processing proceeds to step S1912, were the CPU 1301 calculates the amount of power that can be transferred to another image forming apparatus based on the predicted power consumption of each image forming apparatus, and judges with respect to each image forming apparatus whether or not a power amount can be transferred therefrom. Here, the processing proceeds to step S1914 if it is determined that a power amount cannot be transferred, whereas if it is determined that a power amount can be transferred, the processing proceeds to step S1913, where the allocation method set in the reallocation method setting screen 1604 in FIG. 6 is confirmed. Next, the processing proceeds to step S1914, where the CPU 1301 transmits to target image forming apparatuses information on a power stock or the transferable amount of power of each image forming apparatus, information for resetting the target amount of power, or information indicating that allocation is not allowed.

Consequently, in step S1915, the CPU 1201 of the image forming apparatus receives the information transmitted in step S1914, re-sets target power consumption or updates the power saving transition power amount, in accordance with the received information. Further, if allocation is not allowed, the image forming apparatus operates in the same state as the former state.

Next, the processing proceeds to step S1916, the above flow is repeated until the end of the power control time period set in 1502 in FIG. 5, and the processing transitions to step S1917 at the point in time when the power control time period ends, where each image forming apparatus transmits the accumulated power consumption at the point in time when that time period ends to the management apparatus 106. Consequently, in step S1918, the CPU 1301 of the management apparatus 106 records the received power consumption in the RAM 1302 and the HDD 1304.

The above is a description of operation including a mutual cooperative operation with information on the target power consumption, a dynamic change, and the like transmitted/received between the image forming apparatuses and the management apparatus 106. Although the flow described above shows an example in which the management apparatus 106 manages calculation and setting of the amount of power, and the like, a configuration may be adopted in which an image forming apparatus independently performs management.

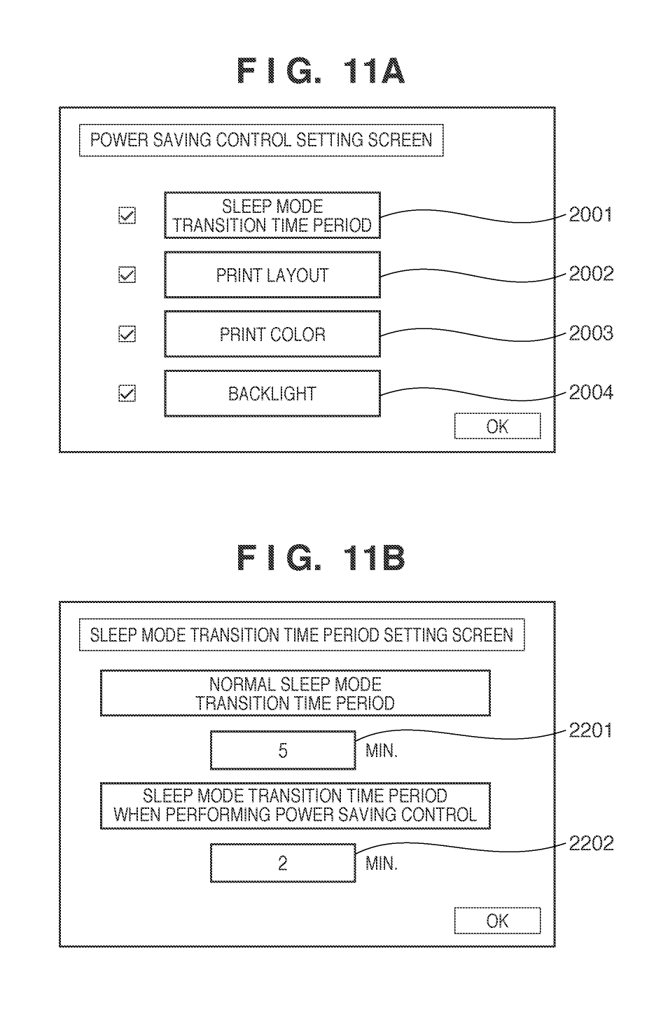

Next, with reference to FIGS. 11A and 11B to FIG. 13, an example of a user interface for the user to set operation that an image forming apparatus implements in the electric power saving mode is described.

FIG. 11A is a diagram showing an example of a power saving control setting screen displayed on the console unit 140 of the image forming apparatus according to the present embodiment.

This power saving control setting screen includes a sleep mode transition time period setting button 2001, a print layout setting button 2002, a print color setting button 2003, and a backlight setting button 2004. Further, each button has a check box for making the setting valid or invalid. The sleep mode transition time period setting button 2001 is for setting a time period for transitioning to the sleep state in the case where power saving control is performed. For example, although when performing normal operation, a transition is made to the sleep state in the case where, for example, a user operation is not performed for a predetermined time period, a time period shorter than that predetermined time period is set. The print layout button 2002 is for, if power saving control is performed, setting so as to perform printing in accordance with reduced layout setting. For example, a setting of a print layout including 2 in 1, 4 in 1, double-sided printing, and the like is received. The print color setting button 2003 is for setting so as to forcedly limit printing to monochrome printing and perform printing if power saving control is performed. For example, monochrome printing is set by turning off a function of detecting the color of an original read with the scanner unit 10. The backlight setting button 2004 is for setting so as to reduce the amount of light of the backlight of the display unit of the console unit 140 if power saving control is performed. The content set via such power saving control setting screens is recorded in the RAM 1202 or the HDD 1204 by the CPU 1201 when an OK button is instructed.

Note that the power saving control settings shown in FIG. 11A are examples of power saving control in the power saving control system according to the present embodiment, and are not limited to the examples shown in the drawing. Other than this, it is sufficient that the setting is parameter setting and operational mode setting that have power saving effect for image forming apparatuses.

FIG. 11B is a diagram showing an example of a sleep mode transition time period setting screen of the power saving control setting screens according to the present embodiment. This screen is displayed by the sleep mode transition time period setting button 2001 in FIG. 11A being instructed.

This sleep mode transition time period setting screen includes a field 2201 for inputting a sleep mode transition time period when performing normal operation, and a field 2202 for inputting a sleep mode transition time period when performing power saving control. In the example shown in the drawing, a time period for transitioning to the electric power saving mode if there is no data input or user operation for a predetermined time period is set to five minutes in the normal mode, and set to two minutes when performing power saving control.

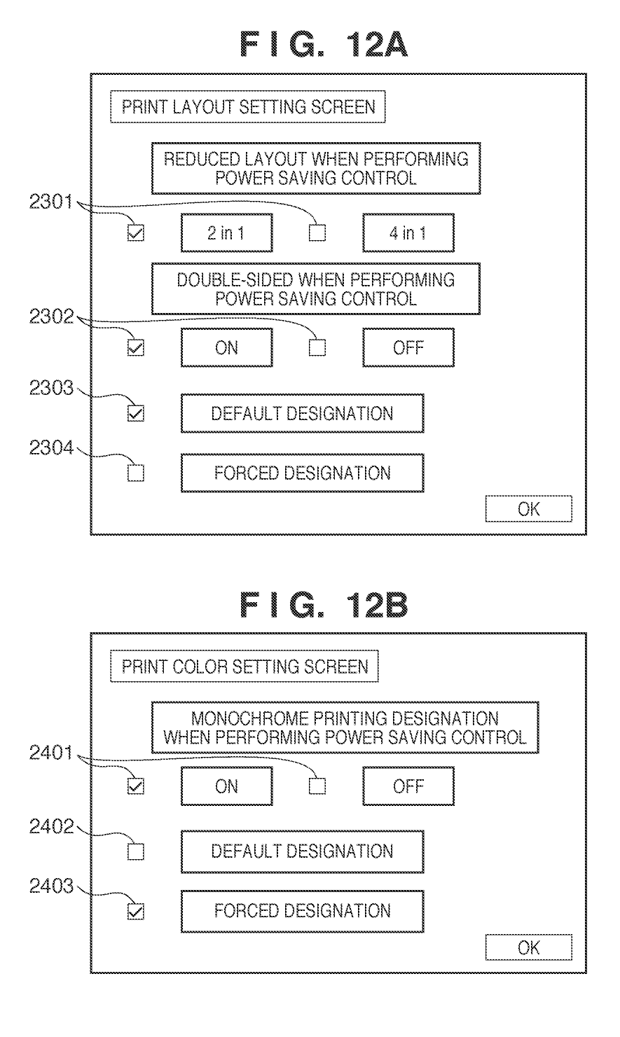

FIG. 12A is a diagram showing an example of a print layout setting screen of the power saving control setting screens according to the present embodiment. This screen is displayed by the print layout setting button 2002 in FIG. 11A being instructed.

This print layout setting screen includes a choice item for choosing a reduced layout used when performing power saving control using a check box 2301. Whether to “perform” or “not to perform” double-sided printing when performing power saving control can be chosen using check boxes 2302. Further, the screen includes a choice item 2303 for setting the setting results of the above items as default setting and a choice item 2304 for setting the setting results of the above items as forced setting. In the example shown in the drawing, “2 in 1” is designated as a reduced layout, and double-sided setting is designated to be “performed (ON)”, and these settings are set to be designated by default.

FIG. 12B is a diagram showing an example of a print color setting screen of the power saving control setting screens according to the present embodiment. This screen is displayed by the print color setting button 2003 in FIG. 11A being instructed.

This print color setting screen includes choice items 2401 for setting whether or not to designate monochrome printing when performing power saving control, and a choice item 2402 for setting this setting as default setting. Further, this screen also includes a choice item 2403 for setting the setting results of the above items as forced setting. In the example shown in the drawing, monochrome printing is designated to be “performed (ON)” when performing power saving control, and “forced designation” is checked. In this case, only monochrome printing is executed in the electric power saving mode.

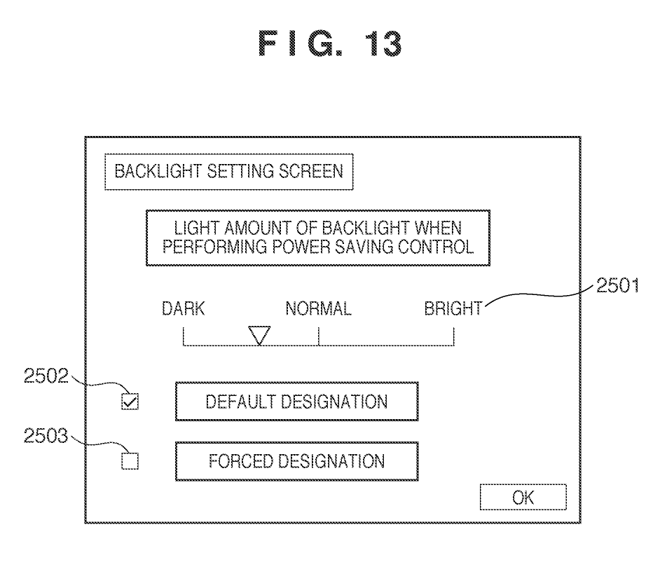

FIG. 13 is a diagram showing an example of a backlight setting screen of the power saving control setting screens according to the present embodiment. This screen is displayed by the backlight setting button 2004 in FIG. 11A being instructed.

This backlight setting screen includes an adjustment item 2501 for setting the light amount of the backlight of the display unit of the console unit 140 when performing power saving control, and a choice item 2502 for setting the setting result as default setting. Further, this screen also includes a choice item 2503 for setting the setting results of the above items as forced setting. In the example shown in the drawing, the light amount of the backlight is set to be slightly darker than normal, and “default designation” is set.

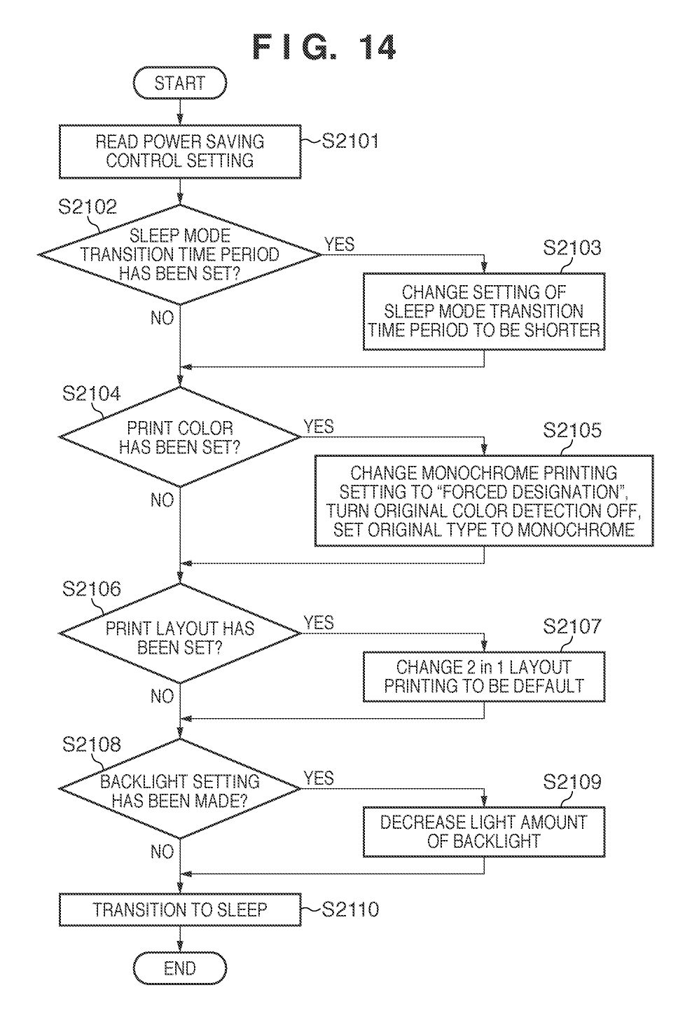

FIG. 14 is a flowchart illustrating the operation of the image forming apparatuses in the electric power saving mode according to the present embodiment. Note that this processing is achieved by the CPU 1201 executing the program loaded into the RAM 1202.

In step S2101, the CPU 1201 reads set content of the power saving control from the RAM 1202 or the HDD 1204 in the electric power saving mode. Next, the processing proceeds to step S2102, where the CPU 1201 determines whether or not sleep mode transition time period setting is valid based on the read power saving setting. Here, the processing proceeds to step S2104 when the setting is not valid, whereas if it is determined that the setting is valid, the processing proceeds to step S2103, where, for example, a sleep mode transition time period is changed to be shorter (two minutes in the example in FIG. 11B), and the processing proceeds to step S2104. In step S2104, the CPU 1201 determines whether or not print color setting is valid. Here, the processing proceeds to step S2106 when print color setting is not valid, whereas if that setting is set to be valid, the processing proceeds to step S2105, where, for example, monochrome printing is changed to “forced designation” as setting in the example in FIG. 12B, and the processing proceeds to step S2106. In this case, the CPU 1201 makes a setting change, such as turning off a function of detecting the color of an original with the scanner unit 10, fixing an original type to monochrome setting, and the like.

Next, in step S2106, the CPU 1201 determines whether or not print layout setting is valid. Here, the processing proceeds to step S2108 when print layout setting is not valid, whereas the processing proceeds to step S2107 if that setting is valid. In S2107, 2 in 1 layout printing setting is changed to default as shown in FIG. 12A, for example, and the processing proceeds to step S2108. In step S2108, the CPU 1201 determines whether or not backlight setting is valid. The processing proceeds to step S2110 if backlight setting is not valid, whereas if it is valid, the processing proceeds to step S2109, where the CPU 1201 changes the light amount setting of the backlight to be reduced and slightly darker than “normal”, as shown in FIG. 13, for example, and the processing proceeds to step S2110. In step S2110, a transition is made to the sleep state so as to transition to the power saving state.

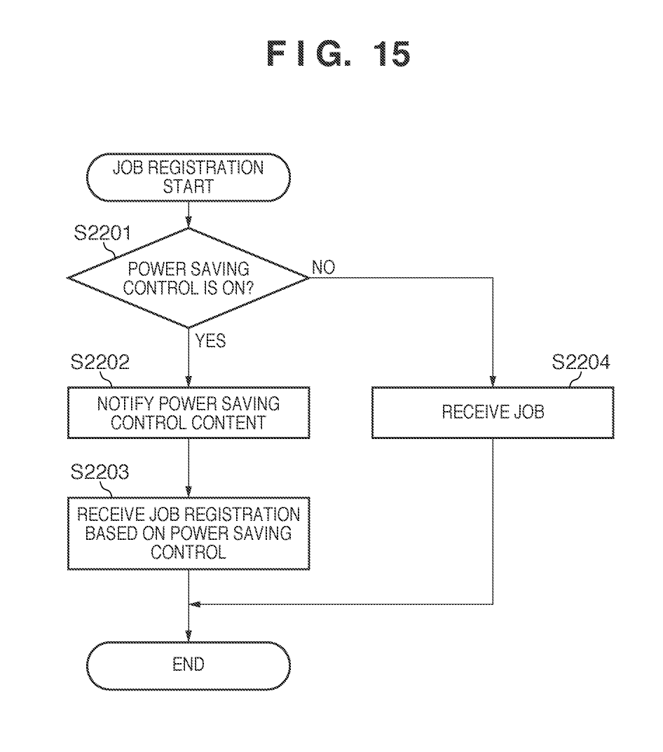

FIG. 15 is a flowchart describing the operation related to job registration of the image forming apparatuses according to the present embodiment. Note that this processing is achieved by the CPU 1201 executing the program loaded into the RAM 1202.

In step S2201, the CPU 1201 determines whether power saving control is being performed based on power saving control in the case of registering a job including advanced condition settings made via the console unit 140 when executing copying and printing. Here, if power saving control is off, the processing proceeds to step S2204, where the CPU 1201 receives normal job registration without restriction. On the other hand, if it is determined in step S2201 that power saving control is being performed, the processing proceeds to step S2202, where the user is notified of the content of power saving control by the display on the console unit 140. Next, the processing proceeds to step S2203, where the CPU 1201 receives job registration based on power saving control.

The image forming apparatuses in the power saving control system as described above determine whether or not power saving control is being performed when a job is registered and receive job registration, thereby preventing job execution conditions from being changed due to power saving control after the job is registered.

As described above, the present embodiment provides effects of, in a use environment of multiple devices that vary in terms of function, performance, operating time period, and operating content, controlling the amount of power consumed by the devices as the whole, and enabling power saving control based on target power consumption.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application. No. 2010-110594, filed May 12, 2010, which is hereby incorporated by reference herein in its entirety.

What is claimed is:

1. A system including a plurality of devices and a management apparatus capable of communicating with the plurality of devices,
wherein the management apparatus comprises:
a reception unit that receives target power consumption of the entire system, and a setting of a time period for performing power saving control;
a setting unit that calculates target power consumption of each device based on the target power consumption of the entire system, and sets the calculated target power consumption for the each device;
an obtaining unit that obtains a power amount reallocation request from a first device in which power consumption of the device has reached a power saving transition power amount corresponding to the target power consumption of the first device;
a calculation unit that calculates, in response to the reallocation request, predicted power consumption of each of the plurality of devices for a point in time when the time period ends, based on power consumption of each of the devices other than the first device and a remaining time period up to the end of the time period; and
an update unit that, based on the predicted power consumption of each of the devices other than the first device calculated by the calculation unit, and the power saving transition power amount and the power consumption of each of the devices, chooses a second device that will not reach the corresponding power saving transition power amount of the device by the end of the time period, determines an amount of power consumption allocatable from the second device to the first device, and updates the power saving transition power amounts of the first and second devices, and
each of the devices comprises:
a measurement unit that measures power consumption of the device;
a transmission unit that, if the power consumption of the device measured by the measurement unit reaches the power saving transition power amount of the device, transmits the power amount reallocation request to the management apparatus;
a transition power update unit that receives the power saving transition power amount updated by the update unit from the management apparatus in response to the reallocation request, and updates the power saving transition power amount corresponding to the device; and
a control unit that controls whether to cause the device to transition to an electric power saving mode, based on the power consumption of the device and the power saving transition power amount corresponding to the device.

2. The system according to claim 1, wherein the power saving transition power amount of each device is an amount of power set to a predetermined percentage with respect to the target power consumption of the device.

3. The system according to claim 1, wherein the update unit chooses, as the second device, a device in which a difference between the predicted power consumption and the power saving transition power amount is the greatest.

4. The system according to claim 1, wherein the update unit, if there are a plurality of devices that will not reach the respective corresponding power saving transition power amounts of the devices by the end of the time period, updates the power saving transition power amount of the first device and the corresponding power saving transition power amounts of the devices such that an amount of power consumption is equally allocated from the plurality of devices to the first device.

5. The system according to claim 1, wherein the setting unit calculates and sets the target power consumption of each device, based on actual power consumption of the plurality of devices in the past.

6. The system according to claim 1, wherein the setting unit equally sets the target power consumption for the plurality of devices.

7. The system according to claim 1, wherein each of the devices has a user interface for a user to set operation in the electric power saving mode.

8. A management apparatus capable of communicating with a plurality of devices, the management apparatus comprising:
a reception unit that receives target power consumption, and a setting of a time period for performing power saving control;
a setting unit that calculates target power consumption of each device based on the target power consumption, and sets the calculated target power consumption for the each device;
an obtaining unit that obtains a power amount reallocation request from a first device in which power consumption of the device has reached a power saving transition power amount corresponding to the target power consumption of the first device;
a calculation unit that calculates, in response to the reallocation request, predicted power consumption of each of the plurality of devices for a point in time when the time period ends, based on power consumption of each of the devices other than the first device and a remaining time period up to the end of the time period; and
an update unit that, based on the predicted power consumption of each of the devices other than the first device calculated by the calculation unit, and the power saving transition power amount and the power consumption of each of the devices, chooses a second device that will not reach the corresponding power saving transition power amount of the device by the end of the time period, determines an amount of power consumption allocatable from the second device to the first device, and updates the power saving transition power amounts of the first and second devices.

9. A method of controlling a system including a plurality of devices and a management apparatus capable of communicating with the plurality of devices, the method comprising:
a reception step of the management apparatus receiving target power consumption of the entire system, and a setting of a time period for performing power saving control;
a setting step of the management apparatus calculating target power consumption of each device based on the target power consumption of the entire system, and setting the calculated target power consumption for the each device;
an obtaining step of the management apparatus obtaining a power amount reallocation request from a first device in which power consumption of the device has reached a power saving transition power amount corresponding to the target power consumption of the first device;
a calculation step of the management apparatus calculating, in response to the request, predicted power consumption of each of the plurality of devices for a point in time when the time period ends, based on power consumption of each of the devices other than the first device and a remaining time period up to the end of the time period;
an update step of, based on the predicted power consumption of each of the devices other than the first device calculated in the calculation step, and the power saving transition power amount and the power consumption of each of the devices, the management apparatus choosing a second device that will not reach the corresponding power saving transition power amount of the device by the end of the time period, determining an amount of power consumption allocatable from the second device to the first device, and updating the power saving transition power amounts of the first and second devices;
a measurement step of each of the devices measuring power consumption of the device;
a transmission step of, if the power consumption of the device measured in the measurement step reaches the power saving transition power amount of the device, each of the devices transmitting the power amount reallocation request to the management apparatus;
a step of each of the devices receiving the power saving transition power amount updated in the update step from the management apparatus in response to the reallocation request, and updating the power saving transition power amount corresponding to the device; and
a control step of each of the devices controlling whether to cause the device to transition to an electric power saving mode, based on the power consumption of the device and the power saving transition power amount corresponding to the device.

10. A method of controlling a management apparatus capable of communicating with a plurality of devices, the method comprising:
a reception step of receiving target power consumption of the entire system, and a setting of a time period for performing power saving control;
a setting step of calculating target power consumption of each device based on the target power consumption of the entire system, and setting the calculated target power consumption for the each device;
an obtaining step of obtaining a power amount reallocation request from a first device in which power consumption of the device has reached a power saving transition power amount corresponding to the target power consumption of the first device;
a calculation step of calculating, in response to the request, predicted power consumption of each of the plurality of devices for a point in time when the time period ends, based on power consumption of each of the devices other than the first device and a remaining time period up to the end of the time period; and
an update step of, based on the predicted power consumption of each of the devices other than the first device calculated in the calculation step, and the power saving transition power amount and the power consumption of each of the devices, choosing a second device that will not reach the corresponding power saving transition power amount of the device by the end of the time period, determining an amount of power consumption allocatable from the second device to the first device, and updating the power saving transition power amounts of the first and second devices.
